(19) United States
(12) Patent Application Publication
(10) Pub. No.: US 2008/0264128 A1
(43) Pub. Date: Oct. 30, 2008

(54) Composting Apparatus Having an Oven

(75) Inventor: Michael Morrison, Victoria (AU)

Correspondence Address: SENNIGER POWERS LLP, ONE METROPOLITAN SQUARE, 16TH FLOOR, ST LOUIS, MO, 63102, US

(73) Assignee: COMPOST OVEN PTY LTD., Melbourne, Victoria (AU)

(21) Appl. No.: 11/814,963

(22) PCT Filed: Jul. 12, 2005
(86) PCT No.: PCT/AU2005/001022

§ 371 Date: Feb. 5, 2008

(30) Foreign Application Priority Data
Jan. 27, 2005 (AU) 2005900340

(51) Int. Cl. C05F 17/00; C05F 17/02

(52) U.S. Cl. 71/9; 435/290.1

(57) ABSTRACT

A composting apparatus having a heating unit is disclosed so that the heating unit is heated by the composting of material in the apparatus. The heating unit (200, 300) may be used to heat foodstuffs or other material such as soil for growing plants or additional compostable material. The heating unit (300) may have holes (307) for allowing air to enter the oven. The unit may also include a conduit which is wrapped around the heating unit for facilitating heating of the heating unit (300) and for also supplying heated fluid to drive a pump or turbine (460). A condensing chamber (430) is provided for allowing heated fluid to condense and a conduit (422) is provided for returning the condensed fluid to the storage chamber (403) within the composting material (C).

### FIELD OF THE INVENTION

This invention relates to a composting apparatus for composting material and having a heating unit for heating material in the oven.

### BACKGROUND OF THE INVENTION

Composting is an environmentally friendly way of disposing of waste organic material. Generally in order to provide good compost, it is desirable that the material aerobically decompose. By providing the right environment for aerobic decomposition, the material can quickly decompose and the quality of the compost is improved.

It is also desirable to collect leachate which drains from the composting material for separate use or to dispose of rather than to allow the leachate simply to drain to the ground.

Composting containers may be required in various different sizes to suit particular applications.

### SUMMARY OF THE INVENTION

The invention provides a composting apparatus comprising:
a composting chamber in which compostable material is locatable for decomposition into compost;
a heating unit within the composting apparatus for receiving an article to be heated; and
wherein heat generated by the composting of material in the apparatus generates heat for heating the unit to heat the article.

The invention also provides a composting apparatus comprising:
a container for receiving a compostable material;
a heat storage chamber in the container;
a condensing chamber exterior of the container;
a first conduit for connecting the storage chamber to the condensing chamber;
an energy supplying device located in the first conduit to be driven by fluid passing from the storage chamber through the first conduit to the condensing chamber; and
a second conduit for returning condensed fluid from the condensing chamber to the storage container so that the fluid can be heated by the composting of the compostable material to thereby heat the fluid in the storage chamber so the fluid passes through the first conduit and drives the energy producing device and condenses in the condensing chamber for return back to the storage chamber.

Further still, the invention also provides a method of heating an article comprising:
providing a composting mass;
locating a heating unit within the composting mass;
locating an article to be heated within the heating unit; and
wherein, as the composting mass aerobically decomposes, heat is generated to heat the heating unit to in turn heat the article within the heating unit.

### BRIEF DESCRIPTION OF THE DRAWINGS

Preferred embodiments of the invention will be described, by way of example, with reference to the accompanying drawings, in which:

FIG. 1 is a view of an embodiment of the present invention;

FIG. 2 is a view of a further embodiment of the invention;

FIG. 3 is a view similar to FIG. 1 but showing the addition of composting material;

FIG. 4 is a view of a still further embodiment of the invention;

FIG. 5 is a diagram illustrating another embodiment of the invention;

FIG. 6 is a view of a further embodiment of the invention; and

FIG. 7 is a view of a still further embodiment of the invention.

### DETAILED DESCRIPTION OF THE PREFERRED EMBODIMENTS

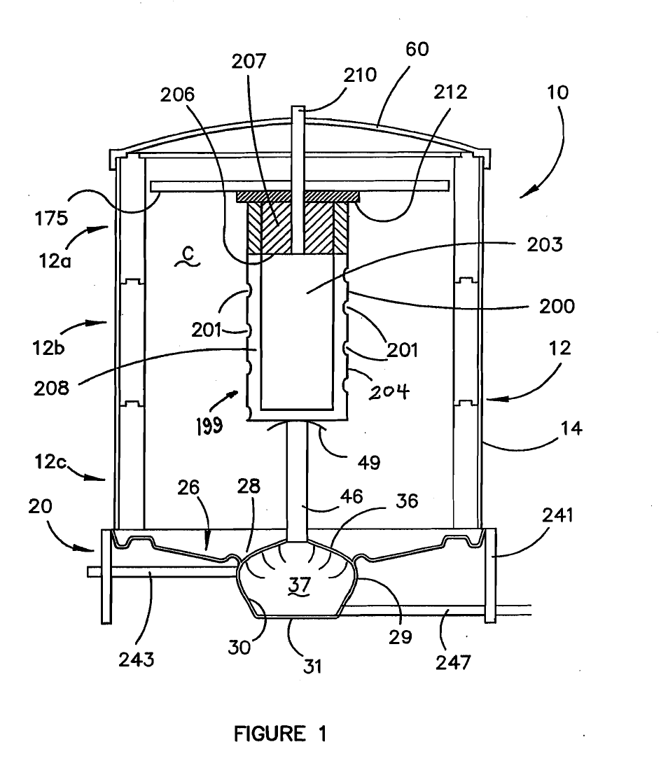

With reference to FIG. 1, a compost apparatus 10 is shown which has a container 12 formed from a plurality of segments 12a, 12b and 12c. As will be apparent hereinafter, the number of segments which may be used is arbitrary and segments can be added to increase the size of the container as desired. However, in general, at least two of the segments will be used to form a composting apparatus, as will also be described in detail hereinafter.

In the preferred embodiment of the invention the segments are generally cylindrical in configuration and define a peripheral wall. The segments are stacked one above the other in order to form the container and a sheath 14 may be slid over the assembled segments to hold the segments together. Alternatively, the segments may include interlocking components such as a small projection at the bottom of the wall of each segment which registers in a correspondingly shaped recess in the top of each wall of the segment.

A base 20 is located in the container 10 and supports on the lowermost segment 12a. An annular bowl wall section 26 defines an opening 28 and a leachate chamber 29 is located in the opening 28. The leachate chamber 29 has a conical wall 30 which is a continuation of the curved bowl wall 26 and the leachate chamber 29 is completed by a lower bottom wall 31.

An air inlet pipe 243 is provided through the side wall 241 of base 20 and communicates with the leachate chamber 29. The leachate chamber 29 may have an open bottom so that the leachate can drain from the chamber 29 onto the ground. However, preferably the chamber is closed by the wall 31 and is provided with a small outlet pipe 247 so that leachate can drain from the pipe 247 and be collected.

A heating unit 199 having a capsule 200 and a heating chamber 203 forms an oven, and is provided in the container. The capsule 200 is located in the apparatus 10 in which compost material C is to be located and composted. The capsule 200 may be located just above the cap 49 and aerator 46. Air inlet into the composting apparatus 10 is via pip 243 through the open bottom chamber 29 and up into the aerator 46.

The capsule 200 may be formed from metal or plastic material which is sufficiently strong to withstand the heat generated in the compost apparatus 10 which can reach a heat of 61° C., which is more than suitable for cooking many foodstuffs, such as bread and beans or heating other articles. The capsule 200 is provided with air holes 201 around lower extremity of peripheral wall 204. A heating chamber 203 is located in the capsule 200 and is spaced from the peripheral side wall 204 of the capsule by space 208. The chamber 203 is formed from a cooking grade material if the chamber is to be used for cooking foodstuffs such as bread or beans. One example of such a material is stainless steel. The chamber 203 has a lid 206 and an insulating block 207 is located on the lid and extends slightly out beyond the periphery of the lid so as to locate over the space 208 between the capsule 200 and the cooking chamber 203. Thus, heat is able to rise during generation of composting of material within the apparatus 10 through the holes 201 and up through the space between the chamber 203 and the capsule 200 and is generally trapped in that space by the insulating block 207 on the lid 203. An air pipe 210 passes from the cooking chamber 203 to the exterior of the apparatus to allow air to escape from the cooking chamber. Thus, as is shown, the tube 210 passes through the insulating block 207, the chamber C in which the composting material is located, and a lid 60 to communicate with the outside environment.

In order to gain access to the chamber 203, the entire chamber 203, together with the block 207 is removed via upper wall section 212, which can form a handle to enable easy removal of the chamber 203 from the capsule 200. In order to do this, the lid 60 is first removed by sliding it over the tube 210.

An insulating mat 175 may be located over the capsule 200 and chamber 203 to facilitate retention of heat within the apparatus 10 and which would also need to be removed before the cooking chamber 203 is removed.

The ability to completely remove the sealed cooking chamber 203 means that the cooking chamber is not contaminated by any of the composting material in the apparatus 10 and since it is also relatively protected by the capsule 200, the exterior of the chamber 203 is clean when removed from the device. If necessary, the chamber 203 can be wiped down before it is opened to gain access to the interior and whatever is heated or cooked in the chamber 203.

The lid 206 may be a screw fit or otherwise secured to the chamber 203 to facilitate removable connection of the lid 206 to the chamber 203 to gain access to the material cooked in the chamber 203.

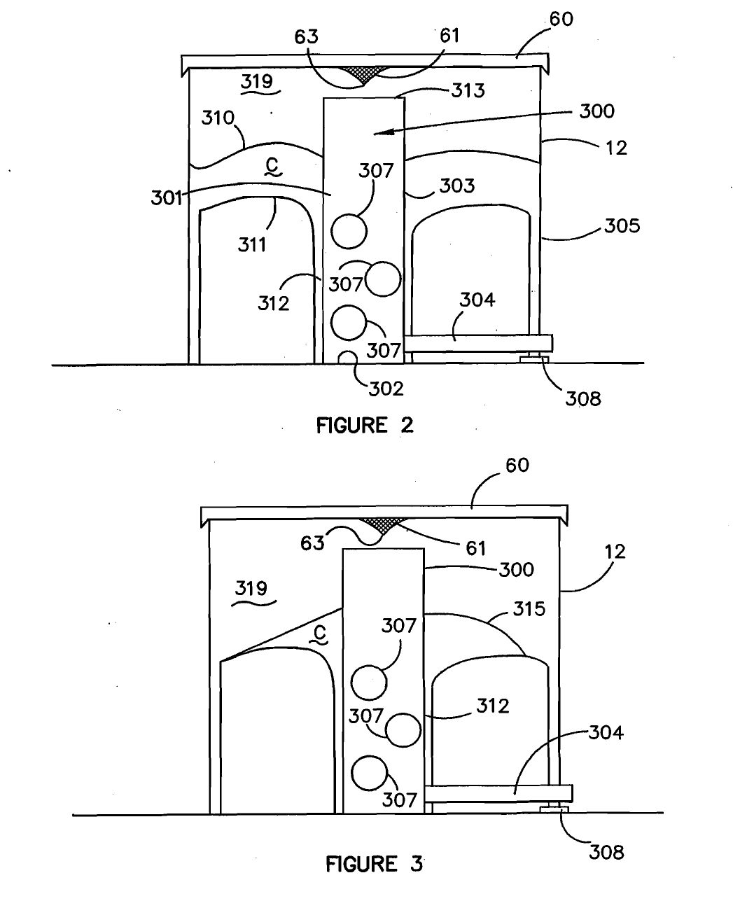

FIGS. 2 and 3 show a still further embodiment of the invention. Like reference numerals indicate like parts to those described with reference to FIG. 1. In this embodiment, container 12 is a generally cylindrical container and is closed by a lid 60. The lid 60 has an internal guide or vane 61 which projects into the interior of the container 12 and has an apex 63. The lid 60 can be flat as illustrated, or can be slightly curved downwardly to the vane 61. An oven 300 is arranged within the container 12 and comprises a cylindrical heating chamber 301 which has a removable lid 313, a base 302 and a peripheral side wall 303. A tube or conduit 304 communicates with the interior of the chamber 301 and extends through peripheral wall 305 of the container 12.

The peripheral wall 303 of the heating chamber 301 is provided with holes 307. The peripheral wall 305 is also provided with an inlet pipe 308 or simply an inlet hole to allow air to enter the container 12, as will be described in more detail hereinafter.

When compost material C is initially loaded into the container 12, the compost partly fills composting chamber 319 which, in this embodiment, is defined by the container 12, as illustrated by line 310.

The heating chamber 301 contains an article to be heated. In this embodiment of the invention, the article may comprise soil which is loaded into the chamber 301 and then closed in the chamber 301 by replacing lid 313.

As the compost material C decomposes, heat is generated to heat the oven 300 so that the soil within the oven 300 is also heated.

As the compost material C breaks down, the compost mass effectively shrinks in size, as is illustrated by line 311 in FIG. 2, to form a gap 312 about the oven 300.

Air which enters the pipe 308 is able to travel below the conduit or passage 304 to the gap 312 and up through the gap 312 to improve aerobic decomposition of the composting material C within the container 12.

The pipe 304 acts to maintain a space beneath the pipe 304 which is not filled by compacting compost, so that air is able to pass from the inlet pipe 308 to the gap 312. In an alternative embodiment, the pipe 308 may extend all of the way to just adjacent the peripheral wall 303 of the oven 300 to deliver air to the gap 312 when it forms.

The heating of the soil within the oven 300 produces a heat reservoir which helps to maintain the temperature within the container 12 to improve aerobic decomposition of the composting mass C.

The holes 307 are particularly advantageous when soil is being heated within the oven 300 because they enable the soil to reach temperatures in excess of 40° C. which pasteurises the soil, making it better for growing plants. Contaminated soil can be cleaned by adding specialty bacteria which, together with the elevated temperature, can remove contaminates such as hydrocarbons. The holes 307 also enables some air to enter the oven 300 which can be desirable, depending on the material which is being heated in the oven and the purpose of that heating. For example, in one embodiment, a plant may grow within the oven 300 by locating a seedling in soil within the oven 300 so that the foliage of the seedling is within the pipe or conduit 304 and the roots within the soil in the oven chamber 301 of the oven 300. The heating of the soil maintains a good growing condition and also pasteurises the soil, as mentioned above. As the plant grows, the plant progresses, through the tube 304 towards the light, and then out of the tube 304 and upwardly.

Further still, the holes 307 can allow the roots to progress out of the oven 300 into the composting material to provide a secondary nutrient for the plant within the composted material once the temperature of the composting mass has dropped.

Condensation which is created by the heat of the composting mass can collect on the internal surface of the lid 60 and drain to the vane 61. The liquid then drains to apex 63 where it can drip off and enter the oven 300 if no lid 301 is provided, or if a hole in the lid 301 is provided to allow water to enter the oven. Thus, this provides a self-watering of the soil within the oven to provide water for the growing plant.

With reference to FIG. 3, line 315 illustrates new composting material which is added to the container 12 which covers the gap 312, thus trapping air in the gap 312 and improving the dispersion of oxygen into the composting material C.

Any carbon dioxide produced during aerobic decomposition can escape through the pipe 308 to maintain a relatively high oxygen environment within the container 12 to support aerobic decomposition of the composting mass C.

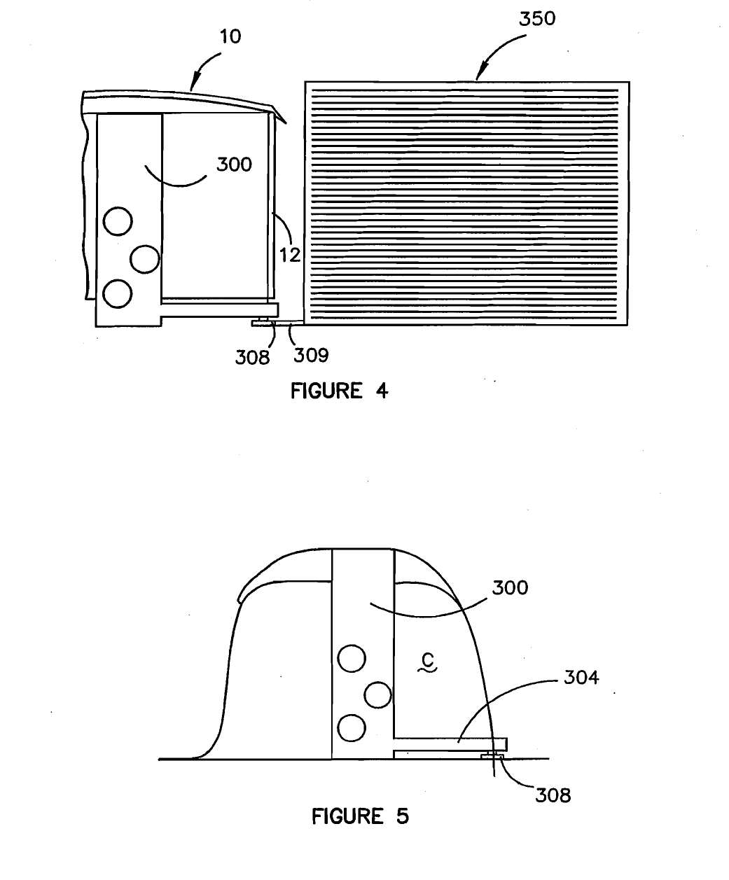

FIG. 4 is a view of a further embodiment which uses the composting apparatus 10 of FIGS. 2 and 3 and also an enclosure 350. The enclosure 350 is in the form of a greenhouse and full structural details are disclosed in my co-pending Australian Provisional Patent Application No. 2005903133 filed 15 Jun. 2005. Any carbon dioxide which exits the pipe 308 can be directed into the enclosure 350 by a branch pipe 309. When the branch pipe 309 is used, air can be supplied through a separate tube 308 or a hole or vertical tube (not shown) conjoined with the tube 308 through which oxygen is able to pass but, because carbon dioxide is somewhat heavier, will remain in the pipe 309 and flow to the enclosure 350.

The container wall 12 can also be formed from a structural member or component as described in the aforementioned Australian provisional patent application. The contents of the aforementioned Australian provisional patent application are incorporated into this specification by this reference, and therefore full structural details need not be given. Thus, suffice it to say that the enclosure 350 or container wall 12 is basically formed from a component which is formed from two sheets which are joined together by a number of weld lines to form elongate chambers which are inflated with air. The component in this form may be used as the outer wall and roof of the enclosure 350 and container wall 12 or, alternatively, a panel can be located on one side of the component or on both sides of the component to form a structural member from which the wall 12 or enclosure 350 can be made.

Apart from heating soil, the oven 300 can be used to heat additional compost material or can be used to compost meat and sewerage, as it has the potential to compost at an elevated temperature if the oven 300 is insulated. In this embodiment, the holes 307 allow fresh oxygen from the gap 312 to enter the oven 300 to support aerobic decomposition of the material within the container 300.

FIG. 5 shows a still further embodiment of the invention in which the oven 300 is simply located in a composting mass C. A pipe 308 is located beneath the conduit or passage 304 and serves to direct air into the composting mass C beneath the conduit 304 to the gap which will form around the oven 300 as the composting mass C shrinks during aerobic decomposition. Thus, in this embodiment, the container 12 is not provided and the composting mass C simply aerobically decomposes as a pile resting on the ground.

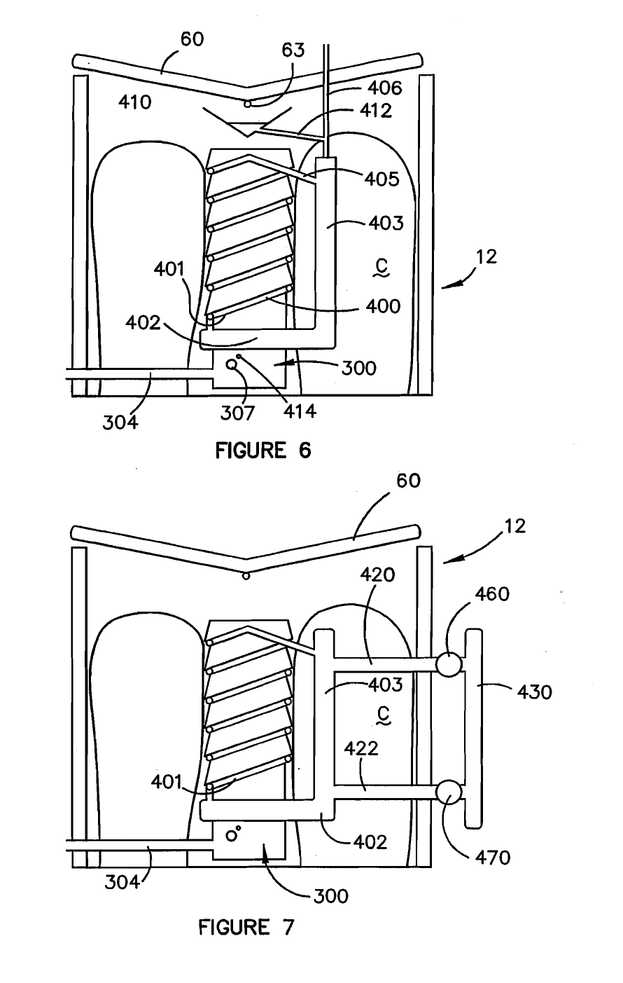

FIG. 6 shows a still further embodiment of the invention in which like reference numerals indicate like parts to those previously described. In this embodiment the oven 300 is provided with a helical groove or undercut 400. The undercut 400 acts as a heat trap for circulating hot air created at the bottom of the composting mass C upwardly along the undercut to warm the oven 300. As more compost material is added to the container 12, the space between the shrunken composting mass C previously described and the oven 300 is filled at the top, thereby providing a stop for maintaining the hot air about the oven 300 for heating the oven 300. Thus, in the early stages of decomposition of the compost material C, the groove 400 acts to slow down the vertical escape of hot air, forcing more heat to be transmitted to the compost oven 300 and its contents.

In a modification to the embodiment just described with reference to FIG. 6, the helical groove 400 can be provided with a helical pipe 401 which connects to a generally horizontal manifold 402. The horizontal manifold 402 connects to a vertical manifold 403 which locates in the composting mass C. The top of the helical pipe 401 has an outlet pipe 405 which communicates with the top of the vertical manifold 403. A pressure release tube 406 extends from the manifold 403 through lid 60. In this embodiment a trough 410 may be provided below apex 63 of the lid 60 for collecting water which condenses on the underside of the lid 60 and a drain pipe 412 is provided which enables the water to flow to the manifold 403 through the pressure release tube 406.

Heat generated by the composting mass C will warm a fluid in the manifolds 402 and 403 so the fluid circulates about the helical tube 401 from the bottom to the top and back to the manifold 403. In the preferred embodiment the fluid comprises water. As the water in the manifold 403 heats up, heat is conducted from a top portion of the manifold down towards the bottom of the manifold and into the vertical manifold 402, thereby increasing the temperature in the lower zone of the composting mass C. This improves the speed and thoroughness of the composting of the composting mass C. Small holes 414 may be provided adjacent the bottom of the oven 300 through which a skewer passes so as to help hold the material which is to be heated in the oven 300 above the bottom of the oven 300. The hole 414 is slightly above hole 307 so it holds the composting mass above the hole 307 so air can enter the hole 307 to allow air to feed to the material if the material being heated in the oven 300 is compostable material.

The vertical manifold 403 is insulated so heat is supplied from the horizontal manifold 402 into the composting material C. This prevents the material C around the manifold 403 from becoming too dry. The composting material C at the bottom of the container 12 near manifold 402 is usually the wettest and therefore heat from the manifold 402 helps drive water upwardly through the dryer regions of the composting material to maintain good moisture content throughout the composting material.

In the embodiment of FIG. 7 the manifold 403 is provided with an upper conduit 420 and a lower conduit 422 which communicate with a storage chamber 430 external of the container 12. A pump, turbine or like device 460 is provided in the conduit 420 and at least one valve 470 is provided in the conduit 422. In this embodiment the manifolds 402 and 403 and chamber 430 are filled with low temperature evaporating liquid such as LPG or the like. As the liquid heats up in the manifold 402 and 403 because of the heat generated by the composting mass C and circulates about the tube 401, the liquid is converted to high pressure gas. The gas will pass through the conduit 420 to drive the pump or turbine 460 and then flow into the manifold 430 where the gas is able to condense and flow back to the manifolds 402 and 403 via the valve 470 and conduit 422. The valve 470 is adjusted to provide the required flow characteristics so the gas drives the device 460.

The pump or turbine 460 may be used to directly pump water for supplying water or may be used to turn a generator for supplying electricity. Thus, in this embodiment the compost unit including the oven 300 is used to provide an energy source for pumping water or providing electricity for external use.

It is possible to use large numbers of compost ovens in combination in a large scale compost mass area plumbed together to tap the heat from a large scale compost site. In a commercial setting the compost ovens could be much taller and larger in diameter and the compost material could be loaded from the top and retrieved from the bottom in a continuous system. Having compost ovens in position and making the diameter the right size would slow down the descent of the material preventing compaction but still allowing the material to flow down while at the same time giving very good aeration and continually bringing the heat down to the lower region driving the water up through the compost mass as vapor and intensifying the wetting effect in the mid region which is normally the region that is the hardest to keep moisturized. This would ensure very even high temperature composting.

Thus, in this way, an article can be heated at the same time as composting material. The heating may simply be a heating of an article for any purpose or cooking of a foodstuff such as bread.

Preferably the heating unit comprises a capsule, a heating chamber in the capsule and spaced from the capsule about at least a peripheral portion of the heating chamber to thereby provide a space, openings in the capsule so that heat generated in the apparatus can pass through the openings into the space to heat the heating chamber, an insulating member locatable on the heating chamber for retaining heat in the space about the heating chamber and in the heating chamber.

Preferably the openings are provided in a lower portion of the capsule.

Preferably the heating chamber has a lid, the insulating member being an insulating block located on the lid and extending beyond the periphery of the lid so the block overlies the space to shut off the space so that heat passing through the openings is trapped in the space, and an air path from the heating chamber to the outside environment.

Preferably the composting apparatus has a lid and the air path passes through the lid.

Preferably the insulating block has an upper wall for facilitating removal of the insulating block and the heating chamber from the capsule as a sealed unit to prevent contamination of the article in the heating chamber from the composting material.

Preferably the composting apparatus includes an aerator for delivering air into the composting chamber for facilitating an aerobic decomposition of the composting material.

In another embodiment of the invention, the heating unit comprises a generally cylindrical oven having a conduit extending from the composting chamber to the exterior of the composting chamber, and a plurality of holes in the oven.

Preferably an air inlet is provided beneath the conduit so that air can pass into the composting mass to facilitate aerobic decomposition and carbon dioxide can pass out of the container.

In one embodiment the oven contains soil for supporting the growing of a plant with the roots of the plant being located in the oven and the foliage of the plant extending through the conduit and growing towards the light at the end of the conduit outward of the container.

In one embodiment of the invention the apparatus includes a fluid storage for location in the compostable material, a condensing chamber exterior of the compostable material, a first conduit for connecting the storage chamber to the condensing chamber, the first conduit including an energy producing device which is driven by fluid passing through the first conduit from the storage container to the condensing chamber, and a second conduit for supplying fluid back from the condensing chamber to the storage chamber.

In one embodiment the device comprises a pump or turbine. In this embodiment of the invention the storage chamber preferably connects to a helical tube which surrounds the heating unit.

Preferably the heating unit has a helical groove and the tube locates in the helical groove.

Preferably the apparatus has a heating unit for location in the compostable material, a conduit wrapped around the heating unit and having one end connected to one part of the storage chamber and a second end connected to another part of the storage chamber so that heated fluid can flow through the conduit wrapped around the heating unit to assist in heating the heating unit.

Preferably the heating unit is provided with a helical groove and the conduit about the heating unit is provided in the helical groove.

Preferably the storage chamber comprises a substantially vertical manifold and a substantially horizontal manifold, the vertical manifold being connected to the conduit surrounding the heating chamber at the top of the vertical manifold and the other end of the conduit being connected to the horizontal storage chamber.

In one embodiment the method also includes allowing air to enter the heating unit through at least one air inlet.

In one embodiment the article to be heated comprises soil and a plant is located in the soil. In this embodiment the heating unit may be provided with a conduit extending outwardly of the composting and the foliage of the plant located in the compost so the foliage grows towards the light at the end of the conduit outward of the composting mass.

Since modifications within the spirit and scope of the invention may readily be effected by persons skilled within the art, it is to be understood that this invention is not limited to the particular embodiment described by way of example hereinabove.

In the claims which follow and in the preceding description of the invention, except where the context requires otherwise due to express language or necessary implication, the word “comprise”, or variations such as “comprises” or “comprising”, is used in an inclusive sense, i.e. to specify the presence of the stated features but not to preclude the presence or addition of further features in various embodiments of the invention.

What is claimed is:

1. A composting apparatus comprising:
a composting chamber in which compostable material is locatable for decomposition into compost;
a heating unit within the composting apparatus for receiving an article to be heated; and
wherein heat generated by the composting of material in the apparatus generates heat for heating the unit to heat the article.

2. The apparatus of claim 1 wherein the heating unit comprises a capsule, a heating chamber in the capsule and spaced from the capsule about at least a peripheral portion of the heating chamber to thereby provide a space, openings in the capsule so that heat generated in the apparatus can pass through the openings into the space to heat the heating chamber, an insulating member locatable on the heating chamber for retaining heat in the space about the heating chamber and in the heating chamber.

3. The apparatus of claim 2 wherein the openings are provided in a lower portion of the capsule.

4. The apparatus of claim 2 wherein the heating chamber has a lid, the insulating member being an insulating block located on the lid and extending beyond the periphery of the lid so the block overlies the space to shut off the space so that heat passing through the openings is trapped in the space, and an air path from the heating chamber to the outside environment.

5. The apparatus of claim 1 wherein the composting apparatus has a lid and the air path passes through the lid.

6. The apparatus of claim 4 wherein the insulating block has an upper wall for facilitating removal of the insulating block and the heating chamber from the capsule as a sealed unit to prevent contamination of the article in the heating chamber from the composting material.

7. The apparatus of claim 1 wherein the composting apparatus includes an aerator for delivering air into the composting chamber for facilitating an aerobic decomposition of the composting material.

8. The apparatus of claim 1 wherein the heating unit comprises a generally cylindrical oven having a conduit extending from the composting chamber to the exterior of the composting chamber, and a plurality of holes in the oven.

9. The apparatus of claim 8 wherein an air inlet is provided beneath the conduit so that air can pass into the composting mass to facilitate aerobic decomposition and carbon dioxide can pass out of the container.

10. The apparatus of claim 8 wherein the oven contains soil for supporting the growing of a plant with the roots of the plant being located in the oven and the foliage of the plant extending through the conduit and growing towards the light at the end of the conduit outward of the container.

11. The apparatus of claim 1 wherein the apparatus includes a fluid storage for location in the compostable material, a condensing chamber exterior of the compostable material, a first conduit for connecting the storage chamber to the condensing chamber, the first conduit including an energy producing device which is driven by fluid passing through the first conduit from the storage container to the condensing chamber, and a second conduit for supplying fluid back from the condensing chamber to the storage chamber.

12. The apparatus of claim 11 wherein the device comprises a pump or turbine.

13. The apparatus of claim 11 wherein the storage chamber connects to a helical tube which surrounds the heating unit.

14. The apparatus of claim 13 wherein the heating unit has a helical groove and the tube locates in the helical groove.

15. A composting apparatus comprising:
a container for receiving a compostable material;
a heat storage chamber in the container;
a condensing chamber exterior of the container;
a first conduit for connecting the storage chamber to the condensing chamber;
an energy supplying device located in the first conduit to be driven by fluid passing from the storage chamber through the first conduit to the condensing chamber; and
a second conduit for returning condensed fluid from the condensing chamber to the storage container so that the fluid can be heated by the composting of the compostable material to thereby heat the fluid in the storage chamber so the fluid passes through the first conduit and drives the energy producing device and condenses in the condensing chamber for return back to the storage chamber.

16. The apparatus of claim 15 wherein the apparatus has a heating unit for location in the compostable material, a conduit wrapped around the heating unit and having one end connected to one part of the storage chamber and a second end connected to another part of the storage chamber so that heated fluid can flow through the conduit wrapped around the heating unit to assist in heating the heating unit.

17. The apparatus of claim 16 wherein the heating unit is provided with a helical groove and the conduit about the heating unit is provided in the helical groove.

18. The apparatus of claim 15 wherein the storage chamber comprises a substantially vertical manifold and a substantially horizontal manifold, the vertical manifold being connected to the conduit surrounding the heating chamber at the top of the vertical manifold and the other end of the conduit being connected to the horizontal storage chamber.

19. A method of heating an article comprising:
providing a composting mass;
locating a heating unit within the composting mass;
locating an article to be heated within the heating unit; and
wherein, as the composting mass aerobically decomposes, heat is generated to heat the heating unit to in turn heat the article within the heating unit.

20. The method of claim 19 wherein the method also includes allowing air to enter the heating unit through at least one air inlet.

21. The method of claim 19 wherein the article to be heated comprises soil and a plant is located in the soil.

22. The method of claim 19 wherein the heating unit may be provided with a conduit extending outwardly of the composting and the foliage of the plant located in the compost so the foliage grows towards the light at the end of the conduit outward of the composting mass.
